(19) United States
(12) Patent Application Publication
(10) Pub. No.: US 2025/0370316 A1
(43) Pub. Date: Dec. 4, 2025

(54) OPTICAL APPARATUS AND IMAGE MODULE THEREOF

(71) Applicant: GUANGZHOU LUXVISIONS INNOVATION TECHNOLOGY LIMITED, Guangzhou City (CN)

(72) Inventor: Cheng-Te Tseng, Guangzhou City (CN)

(73) Assignee: GUANGZHOU LUXVISIONS INNOVATION TECHNOLOGY LIMITED, Guangzhou City (CN)

(21) Appl. No.: 19/047,128

(22) Filed: Feb. 6, 2025

(30) Foreign Application Priority Data
May 29, 2024 (CN) 202410683432.0

(51) Int. Cl. G03B 17/56; G02B 27/01; G02B 27/28

(52) U.S. Cl. CPC G03B 17/561; G02B 27/0172; G02B 27/283; G02B 2027/0138; G02B 2027/0178

(57) ABSTRACT

An optical apparatus includes a bracket, an image module, and an adjustment assembly. The bracket includes a bracket entrance pupil opening and a locking hole adjacent to the bracket entrance pupil opening. The image module is disposed on the bracket, the image module includes an exit pupil area, and the exit pupil area faces the bracket entrance pupil opening. The adjustment assembly includes an adjustment sheet, an elastic member, and an adjustment screw. The adjustment sheet is fastened on a side of the image module facing the bracket and includes an adjustment hole corresponding to the locking hole. The elastic member is disposed on the bracket and is disposed around the bracket entrance pupil opening. The adjustment screw passes through the adjustment hole of the adjustment sheet and is screwed into the locking hole to enable the adjustment sheet to abut against the elastic member.

### CROSS-REFERENCE TO RELATED APPLICATION

This non-provisional application claims priority under 35 U.S.C. § 119(a) to Patent Application No. 202410683432.0 filed in China on May 29, 2024, the entire contents of which are hereby incorporated by reference.

### BACKGROUND

### Technical Field

The present invention relates to an optical apparatus, and in particular, to an optical apparatus that includes an image module wherein a position of the image module can be adjusted.

### Related Art

Augmented reality glasses are a product that can superimpose video information and images seen by eyes of a user in real life and can provide the user with richer entertainment and information experiences. For example, the augmented reality glasses are applied to projection of images of games, navigation, and the like.

The augmented reality glasses generally include an image module for projecting an image. The image projected by the image module is projected, through pupil expansion, onto a waveguide sheet corresponding to the eyes of the user, so that the user can view, from the waveguide sheet, the image generated by the image module. However, many augmented reality glasses have problems of visual discomfort when used by users. For example, focal lengths of the images projected by the image module are different, or a superimposition effect of an image in a left eye and an image in a right eye is poor. As a result, the users have dizziness, visual fatigue, or eye discomfort during use.

### SUMMARY

In view of this, the present invention provides an optical apparatus and an image module. The optical apparatus includes a bracket, the image module, and an adjustment assembly. The bracket includes a bracket entrance pupil opening and a locking hole adjacent to the bracket entrance pupil opening. The image module is disposed on the bracket, the image module includes an exit pupil area, and the exit pupil area faces the bracket entrance pupil opening. The adjustment assembly includes an adjustment sheet, an elastic member, and an adjustment screw. The adjustment sheet is fastened on a side of the image module facing the bracket and includes an adjustment hole corresponding to the locking hole. The elastic member is disposed on the bracket and is disposed around the bracket entrance pupil opening. The adjustment screw passes through the adjustment hole of the adjustment sheet and is screwed into the locking hole to enable the adjustment sheet to abut against the elastic member.

In an embodiment, the bracket includes a plurality of locking holes, and the adjustment sheet includes a plurality of adjustment holes respectively corresponding to the plurality of locking holes. A line connecting centers of at least two locking holes passes through an optical axis of the image module.

In an embodiment, the image module includes a bearing portion, a groove opening is provided on a side of the bracket facing the image module, and the bearing portion passes through the adjustment sheet and is disposed in the groove opening of the bracket.

In an embodiment, the adjustment sheet further includes at least one positioning hole, and the bracket further includes at least one positioning post passing through the at least one positioning hole.

In an embodiment, a glass frame body and a waveguide sheet are further included. The glass frame body bracket is disposed on the glass frame body. The waveguide sheet is disposed between the glass frame body and the bracket, the waveguide sheet includes an entrance pupil area, and the entrance pupil area corresponds to the bracket entrance pupil opening, where a first included angle is defined between a normal of the entrance pupil area and the optical axis of the image module.

In an embodiment, the bracket has an upper surface and a lower surface that are opposite to each other. A second included angle is defined between the upper surface and the lower surface, and an angle of the second included angle is the same as an angle of the first included angle. The image module is disposed on the upper surface of the bracket, and the waveguide sheet is parallel to the lower surface of the bracket.

The present invention further provides an optical apparatus, including a bracket, an image module, and an adjustment assembly. The bracket includes a bracket entrance pupil opening and a locking hole adjacent to the bracket entrance pupil opening. The image module is disposed on the bracket, and the image module includes a housing, a light source, a lens assembly, a modulation assembly, and a polarizing beam splitter. The housing includes an exit pupil area, and the exit pupil area faces the bracket entrance pupil opening. The light source is disposed in the housing, the light source generates light traveling in a first direction, and the light includes first polarized light, where the exit pupil area is located in the first direction. The lens assembly is located on an optical path in a second direction that is perpendicular to an optical path in the first direction and includes a lens and a first base body. The lens is disposed on the first base body, and the first base body includes a first thread. The modulation assembly is located downstream of the optical path of the lens assembly in the second direction and fastened on the housing. The modulation assembly includes a modulator and a second base body, the modulator is fastened on the second base body, and the modulator converts the first polarized light into second polarized light that is orthogonal to the first polarized light. The second base body includes a second thread matching the first thread, and the first base body is screwed to the second thread of the second base body through the first thread. The polarizing beam splitter is disposed in the housing, is located downstream of an optical path of the light source, and is located between the light source, the lens assembly and the exit pupil area. The polarizing beam splitter is capable of reflecting the first polarized light, and the second polarized light is capable of passing through the polarizing beam splitter. The adjustment assembly includes an adjustment sheet, an elastic member, and an adjustment screw. The adjustment sheet is fastened on a side of the image module facing the bracket and includes an adjustment hole corresponding to the locking hole. The elastic member is disposed on the bracket and is disposed around the bracket entrance pupil opening. The adjustment screw passes through at least one adjustment hole of the adjustment sheet and is screwed into the locking hole to enable the adjustment sheet to abut against the elastic member.

In an embodiment, a window is provided at a position of the housing facing the second thread, the first base body further includes a toggling portion, the toggling portion is exposed through the window, and the first base body is rotatable in relation to the second base body through toggling of the toggling portion.

In an embodiment, the window has a window height, the first thread has a thread length, and the window height is greater than the thread length.

In an embodiment, the toggling portion has a toggling rod, the window has a first end and a second end that are opposite to each other, and the toggling rod protrudes beyond the window and is displaceable between the first end and the second end.

In an embodiment, the second base body of the modulation assembly includes a buckling member, the housing includes a buckling portion, and the buckling member is buckled to the buckling portion.

The present invention further provides an image module, including a light source, a lens assembly, a modulation assembly, and a polarizing beam splitter. The light source is configured to generate light traveling in a first direction. The light includes a lens assembly of first polarized light. The lens assembly of the first polarized light is located on an optical path in a second direction that is perpendicular to an optical path in a first direction and includes a lens and a first base body. The lens is disposed on the first base body, and the first base body includes a first thread. The modulation assembly is located downstream of the optical path of the lens assembly in the second direction. The modulation assembly includes a second base body and a modulator, the modulator is fastened on the second base body, and the modulator converts the first polarized light into second polarized light that is orthogonal to the first polarized light. The second base body includes a second thread matching the first thread, and the first base body is screwed to the second thread of the second base body through the first thread. The polarizing beam splitter is located downstream of an optical path of the light source and is located between the light source and the lens assembly. The polarizing beam splitter is capable of reflecting the first polarized light, and the second polarized light is capable of passing through the polarizing beam splitter.

### BRIEF DESCRIPTION OF THE DRAWINGS

FIG. 1 is a three-dimensional schematic diagram of an optical apparatus according to an embodiment;

FIG. 2 is a three-dimensional exploded view of the optical apparatus in the embodiment in FIG. 1;

FIG. 3 is a cross-sectional view at a position marked 3-3 in the embodiment in FIG. 1;

FIG. 4 is a cross-sectional view at a position marked 4-4 in the embodiment in FIG. 1;

FIG. 5 is a cross-sectional view of an image module according to an embodiment, and a cross-sectional position thereof is similar to the position marked 3-3 in FIG. 1;

FIG. 6 is a schematic diagram of a traveling route of light in an image module according to an embodiment; and

FIG. 7 is a three-dimensional schematic diagram of an image module according to another embodiment.

### DETAILED DESCRIPTION

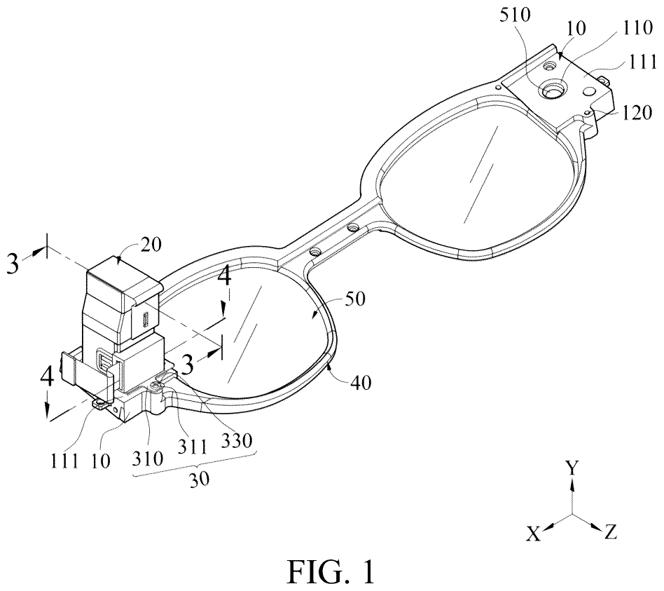

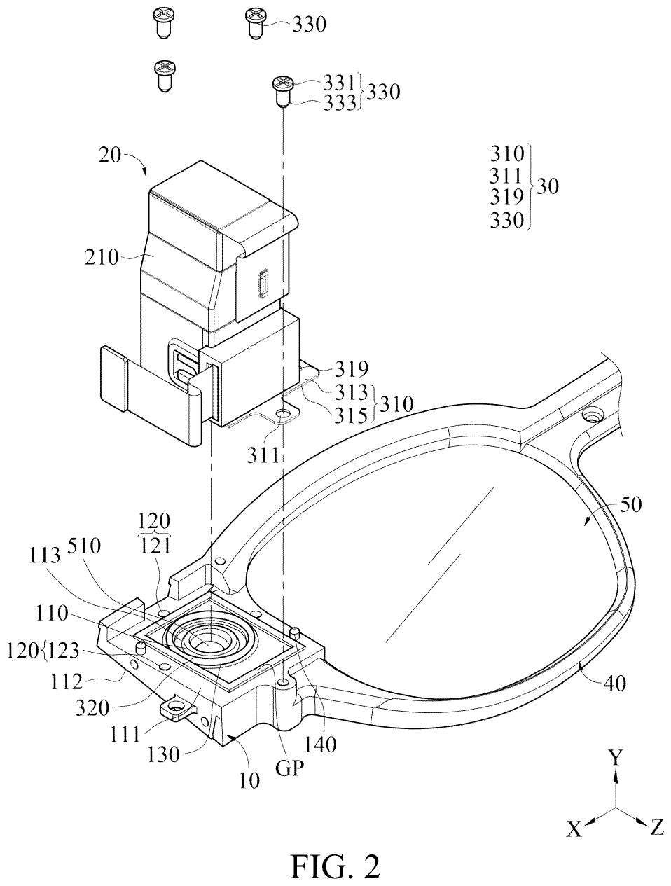

FIG. 1 is a three-dimensional schematic diagram of an optical apparatus according to an embodiment, and FIG. 2 is a three-dimensional exploded view of the optical apparatus in the embodiment in FIG. 1. The optical apparatus includes a bracket 10, an image module 20, and an adjustment assembly 30. The bracket includes a bracket entrance pupil opening 110 and a locking hole 120 adjacent to the bracket entrance pupil opening 110. The image module 20 includes an exit pupil area 211, and the exit pupil area 211 of the image module 20 faces the bracket entrance pupil opening 110 of the bracket 10.

The image module 20 is disposed on the bracket 10, and a position of the image module 20 relative to the bracket 10 is adjusted by using the adjustment assembly 30. The adjustment assembly 30 includes an adjustment sheet 310, an elastic member 320, and at least one adjustment screw 330. The adjustment sheet 310 is fastened on a side of the image module 20 facing the bracket 10, and the adjustment sheet 310 includes an adjustment hole 311 corresponding to the locking hole 120 on the bracket 10. In some embodiments, “corresponding” means that a quantity of adjustment holes 311 is the same as a quantity of locking holes 120, and positions of the adjustment holes 311 are aligned with positions of the locking holes 120.

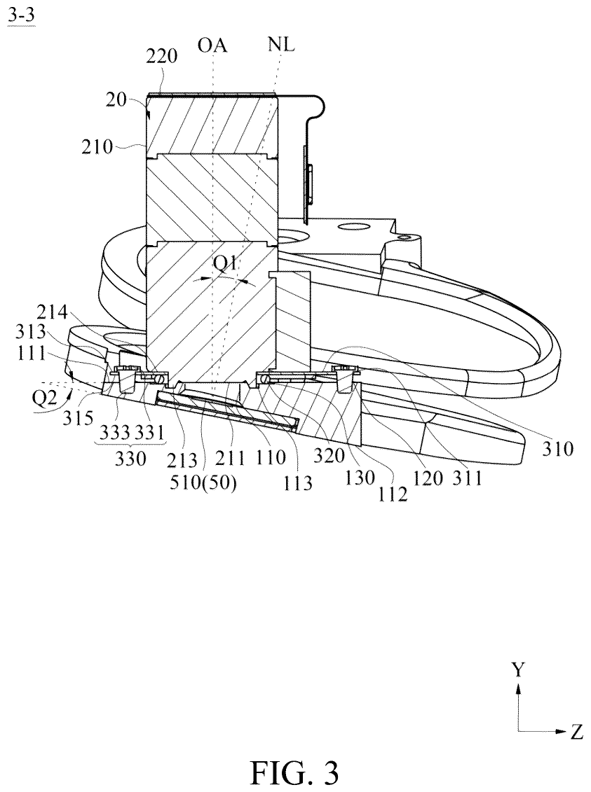

FIG. 3 is a cross-sectional view at a position marked 3-3 in the embodiment in FIG. 1. The elastic member 320 is disposed on the bracket 10 and is disposed around the bracket entrance pupil opening 110. For example, the elastic member 320 may be located between the bracket entrance pupil opening 110 and the locking hole 120. The adjustment screw 330 passes through the adjustment hole 311 of the adjustment sheet 310 and is screwed into the locking hole 120 of the bracket 10 to enable the adjustment sheet 310 to abut against the elastic member 320. A quantity of adjustment screws 330 may be the same as the quantity of adjustment holes 311 and the quantity of locking hole 120, and one adjustment screw 330 passes through one adjustment hole 311 and is screwed into one locking hole 120.

In some embodiments, the optical apparatus may be configured as augmented reality glasses. The optical apparatus may include a glass frame body 40 and a waveguide sheet 50. The bracket 10 is disposed on the glass frame body 40, and the waveguide sheet 50 is disposed between the glass frame body 40 and the bracket 10. Image light generated by the image module 20 reaches the waveguide sheet 50 via the exit pupil area 211 and the bracket entrance pupil opening 110 of the bracket 10. A position of the waveguide sheet 50 corresponding to the bracket entrance pupil opening 110 has an entrance pupil area 510. The image light enters the entrance pupil area 510 to enable, through waveguide pupil expansion, a user wearing the optical apparatus to observe an image generated by the image module 20.

A position between the image module 20 and the bracket 10 is adjusted by using the adjustment assembly 30, so that a position of the image projected by the image module 20 can be adjusted, thereby adjusting quality of the image observed by the user when wearing the optical apparatus. Specifically, when the image module 20 projects the image onto the waveguide sheet 50 and the waveguide sheet 50 performs pupil expansion on the image, if a position of the image presented in a left eye is consistent with a position of the image presented in a right eye, poor bodily sensation or discomfort of the user when viewing the image can be reduced. However, during manufacturing, processing, and assembly of elements such as the waveguide sheet 50, the bracket 10, and the image module 20, errors are prone to occur. These errors may cause the position of the image finally projected onto the left eye of the user and the position of the image finally projected onto the right eye of the user to be different, resulting in a poor image superimposition effect and the foregoing poor bodily sensation.

The adjustment assembly 30 is configured to fine-tune a position of the image module 20 in relation to the bracket 10 and the waveguide sheet 50, an angular relationship between the image module 20 and the waveguide sheet 50 may be changed. Specifically, an angle at which an optical axis of the image module 20 is incident on the waveguide sheet 50 is changed, and a position of the image on a left side that is projected onto the waveguide sheet 50 and a position of the image on a right side that is projected onto the waveguide sheet 50 are adjusted to be consistent with each other, so that the problems caused by the errors in the foregoing manufacturing, processing, and assembly can be resolved.

Still referring to FIG. 3, in some embodiments, the bracket 10 has an upper surface 111, the adjustment sheet 310 has a first surface 313 and a second surface 315 that are opposite to each other, and the second surface 315 faces the upper surface 111 of the bracket 10. The adjustment screw 330 includes a head portion 331 and a shaft portion 333 that are connected to each other. The head portion 331 abuts against the first surface 313 of the adjustment sheet 310.

The shaft portion 333 passes through the adjustment hole 311, a part of the shaft portion 333 is screwed into the locking hole 120 to enable the adjustment sheet 310 to abut against the elastic member 320, and the elastic member 320 is located between the second surface 315 and the upper surface 111.

In some embodiments, the shaft portion 333 of the adjustment screw 330 is a long cylinder extending in an axial direction, and a direction perpendicular to the axial direction is defined as a radial direction. A radial size of the head portion 331 may be greater than a radial size of the adjustment hole 311 on the adjustment sheet 310, so that the head portion 331 is limited to the adjustment sheet 310 and is located on the first surface 313 of the adjustment sheet 310.

In some embodiments, the upper surface 111 of the bracket 10 has a groove 113, and the elastic member 320 may be located in the groove 113 to limit a position of the elastic member 320 on the bracket 10. The elastic member 320 has a thickness, and a depth of the groove 113 may be less than the thickness of the elastic member 320, so that when the elastic member 320 is disposed in the groove 113 of the bracket 10, the second surface 315 of the adjustment sheet 310 and the upper surface 111 of the bracket 10 can be spaced by a distance.

In some embodiments, the adjustment screw 330 is linearly displaced in relation to the bracket 10, and the part of the shaft portion 333 screwed into the locking hole 120 increases or decreases with a direction and a distance of the linear displacement of the adjustment screw 330. That “the adjustment sheet 310 is fastened on a side of the image module 20 facing the bracket 10” means that the image module 20 abuts against the first surface 313 of the adjustment sheet 310. When the adjustment screw 330 is linearly displaced in a direction toward the bracket 10 and a larger part of the shaft portion 333 is screwed into a corresponding locking hole 120, the head portion 331 abuts against the first surface 313 of the adjustment sheet 310 to enable a part of the adjustment sheet 310 on a periphery of the adjustment screw 330 moves in a direction toward the locking hole 120 on the bracket 10. The elastic member 320 is compressed due to the movement of the adjustment sheet 310, and the image module 20 moves in the direction toward the locking hole 120 with the movement of the adjustment sheet 310.

However, when the adjustment screw 330 moves linearly in a direction away from the bracket 10 and a smaller part of the shaft portion 333 is screwed into the corresponding locking hole 120, the adjustment sheet 310 abuts against the elastic member 320, and pressure exerted on the elastic member 320 decreases. As the head portion 331 of the adjustment screw 330 moves in the direction away from the bracket 10, the elastic member 320 gradually rebounds and abuts against the adjustment sheet 310 so that the adjustment sheet 310 also moves in the direction away from the bracket 10, thereby changing a position of the image module 20.

A quantity of elastic members 320 and a shape of the elastic member 320 are not limited herein. In some embodiments, the elastic member 320 may be in a shape of a ring, a sphere, or a square. If the elastic member 320 is in a shape of a sphere or a square, a plurality of elastic members 320 may be evenly distributed around the bracket entrance pupil opening 110. For example, the elastic member 320 may be in a shape of a ring as shown in FIG. 2 or may be in a shape of three spheres respectively located in a 0-degree direction, a 120-degree direction, and a 240-degree direction of the circular bracket entrance pupil opening 110.

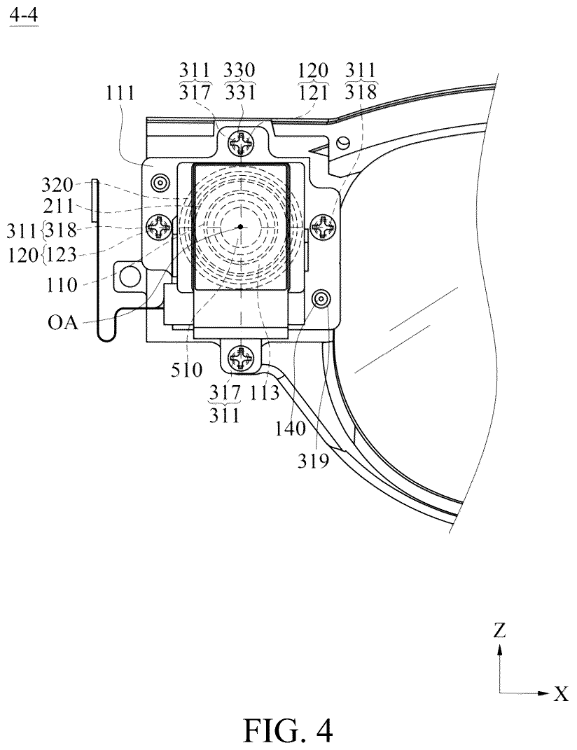

Referring to FIG. 3 and FIG. 4, FIG. 4 is a cross-sectional view at a position marked 4-4 in the embodiment in FIG. 1. In some embodiments, a plurality of adjustment holes 311 are provided on the adjustment sheet 310, and a plurality of locking holes 120 are provided on the upper surface 111 of the bracket 10. Positions of the adjustment holes 311 correspond to the locking holes 120, and the adjustment screws 330 pass through the adjustment holes 311 and are screwed into the locking holes 120.

In some embodiments, there are four adjustment holes 311, four locking holes 120, and four adjustment screws 330, and one adjustment screw 330 passes through one adjustment hole 311 and is screwed into one locking hole 120. The four locking holes 120 include two first locking holes 121 and two second locking holes 123. Two first adjustment holes 317 corresponding to the two first locking holes 121 are respectively located at two ends of the adjustment sheet 310 in a Z direction, and two second adjustment holes 318 corresponding to the two second locking holes 123 are respectively located at two ends of the adjustment sheet 310 in an X direction.

A line connecting the two first locking holes 121 or a line connecting the two second locking holes 123 passes through the optical axis OA of the image module 20, and a position of an intersection between the line connecting the two first locking holes 121 and the line connecting the two second locking holes 123 is aligned with a position of the optical axis OA of the image module 20.

In this way, when the position of the image module 20 relative to the bracket 10 is adjusted by using the adjustment assembly 30, the position of the image module 20 can be adjusted in a Y direction only at a position corresponding to the first adjustment hole 317 or a position corresponding to the second adjustment hole 318. In addition, before and after the adjustment, the optical axis OA of the image module 20 is aligned with a center of the bracket entrance pupil opening 110.

Referring to FIG. 3 again, in some embodiments, the image module 20 includes a bearing portion 213, and the upper surface 111 of the bracket 10 includes a groove opening 130. The bearing portion 213 may pass through the adjustment sheet 310 and may be disposed in the groove opening 130 and thus may be limited to the groove opening 130. A shape of the groove opening 130 may be designed to enable the image module 20 and the bracket entrance pupil opening 110 to serve as fulcrums for each other. The bearing portion 213 may be in a shape of a ring protruding beyond the exit pupil area 211. The groove opening 130 may be between the bracket entrance pupil opening 110 of the bracket 10 and the groove 113 in which the elastic member 320 is placed. When the bearing portion 213 is located in the groove opening 130, a position of the exit pupil area 211 corresponds to the bracket entrance pupil opening 110.

In some embodiments, an abutting portion 214 is disposed on a periphery of the bearing portion 213, and the abutting portion 214 abuts against an upper surface of the adjustment sheet 310 to enable the image module 20 to be stably disposed on the adjustment sheet 310.

Referring to FIG. 2 and FIG. 4 again, in some embodiments, the adjustment sheet 310 includes a positioning hole 319, and the bracket 10 includes a positioning post 140 passing through the positioning hole 319. A quantity of positioning posts 140 may correspond to a quantity of positioning holes 319. An axial center of the positioning post 140 is parallel to the optical axis OA of the image module 20 and prevents the adjustment sheet 310 from moving in a radial direction when the adjustment screw 330 is displaced to cause the adjustment sheet 310 to drive the image module 20 to move. In some embodiments, a shape and a size of the positioning post 140 correspond to a shape and a size of the positioning hole 319.

Still referring to FIG. 2 and FIG. 3, as described above, the image light generated by the image module 20 reaches the entrance pupil area 510 of the waveguide sheet 50 via the exit pupil area 211 of the image module 20 and the bracket entrance pupil opening 110 of the bracket 10, where a first included angle Q1 is defined between a normal NL of the entrance pupil area 510 and the optical axis OA of the image module 20. An angle of the first included angle Q1 may range from 6 degrees to 8 degrees.

As described above, the optical apparatus may be the augmented reality glasses. In general augmented reality glasses, when a user wears the augmented reality glasses, an optical axis of human eyes may be perpendicular to the waveguide sheet 50, and the optical axis of the human eyes is parallel to the optical axis OA of the image module 20. However, in such a configuration, a person (for example, another person standing in front of the user) other than the user may observe, from an other side (an outer side of the waveguide sheet 50) of the waveguide sheet 50 relative to the eyes of the user, image content projected onto the waveguide sheet 50, causing a privacy problem of the user. However, the first included angle Q1 between the normal NL of the entrance pupil area 510 of the waveguide sheet 50 and the optical axis OA of the image module 20 is defined, so that a projection angle of the image light can be changed when the image module 20 is projecting onto the waveguide sheet 50. Therefore, an image that enters the waveguide sheet 50 and is presented, by the waveguide sheet 50 through pupil expansion, to the user for viewing can be projected onto the eyes of the user, while the image is prevented from being directly displayed on the outer side of the waveguide sheet 50, and others are prevented from directly obtaining information projected by the image module 20 for the user to view.

In some embodiments, the bracket 10 has the upper surface 111 and a lower surface 112 that are opposite to each other, and a second included angle Q2 is defined between the upper surface 111 and the lower surface 112. The image module 20 is disposed on the upper surface 111 of the bracket 10; for example, as described above, the image module 20 is fastened on the upper surface 111 by the abutting portion 214. The waveguide sheet 50 is parallel to the lower surface 112 of the bracket 10. In this way, an angle of the second included angle Q2 is the same as the angle of the first included angle Q1. Through this structure, when the user uses the optical apparatus configured as the augmented reality glasses, a person other than the user cannot directly obtain, from the outer side of the waveguide sheet 50, the image projected onto the waveguide sheet 50 by the image module 20.

In some embodiments, the angle of the first included angle Q1 and the angle of the second included angle Q2 range from 6 degrees to 8 degrees.

In some embodiments, the bracket 10, the image module 20, and the adjustment assembly 30 may be first assembled, the first included angle Q1 is first defined between the optical axis OA of the image module 20 and the normal NL of the waveguide sheet 50, and then the position of the image module 20 relative to the waveguide sheet 50 is adjusted by using the adjustment assembly 30. After the adjustment of the adjustment assembly 30 is completed, the adjustment assembly 30 may be fastened between the bracket 10 and the adjustment sheet 310 by glue dispensing. A glue dispensing position GP (shown in FIG. 2) may be between the locking hole 120 of the bracket 10 and the groove 113 for placing the elastic member 320. In some embodiments, the glue dispensing position GP may be arranged in a shape of a ring, arranged in a shape of a square, arranged partially, or the like according to the glue used and a strength requirement of bonding.

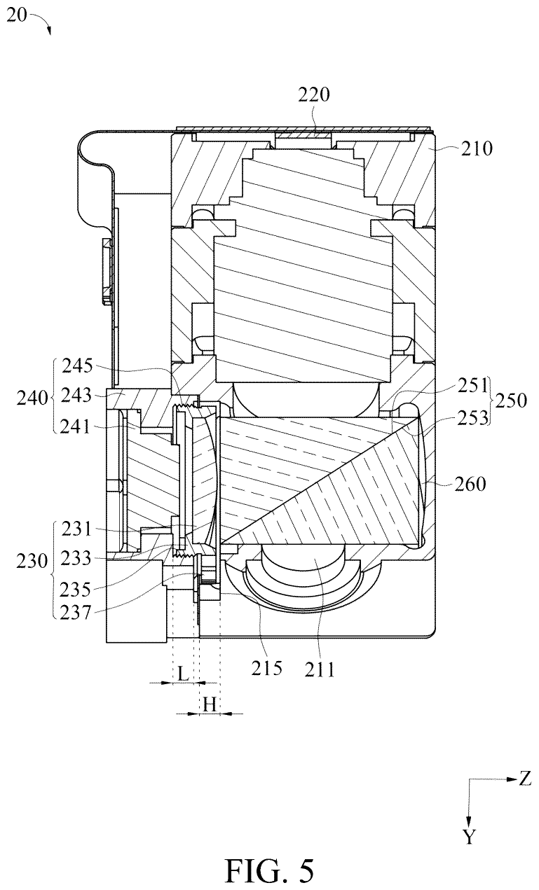

FIG. 5 is a cross-sectional view of an image module according to an embodiment, and a cross-sectional position thereof is similar to the position marked 3-3 in FIG. 1. In some embodiments, the image module 20 includes a housing 210, a light source 220, a lens assembly 230, a modulation assembly 240, and a polarizing beam splitter 250.

The light source 220 is configured to generate light PL0. The light PL0 travels in a first direction, and the lens assembly 230 is located on an optical path in a second direction (a Z direction in FIG. 5) that is perpendicular to an optical path in the first direction. The lens assembly 230 includes a lens 231 and a first base body 233. The lens 231 is disposed on the first base body 233, and the first base body 233 includes a first thread 235. The first thread 235 may be located on an outer side surface of the first base body 233.

The modulation assembly 240 is located downstream of an optical path of the lens assembly 230 in the second direction, and the modulation assembly 240 may be fastened on the housing 210. The modulation assembly 240 includes a modulator 241 and a second base body 243. The modulator 241 is fastened on the second base body 243. The second base body 243 includes a second thread 245, and the second thread 245 may be located on an inner side surface of the second base body 243. The second thread 245 matches the first thread 235 and may be screwed to the first thread 235. The modulator 241 may perform phase modulation on light to change a polarization state of the light and then reflect the light whose polarization state is changed. The polarizing beam splitter 250 is disposed in the housing 210, is located downstream of an optical path of the light source 220, and is located between the light source 220, the lens assembly 230, and an exit pupil area 211 on the housing 210. The polarizing beam splitter 250 may enable P polarized light in the light to completely pass through the polarizing beam splitter 250 and enable S polarized light in the light to be reflected by the polarizing beam splitter 250 by using a case in which when the light is incident at a Brewster's angle, a transmittance of the P polarized light in the light is 1, and a transmittance of the S polarized light is less than 1.

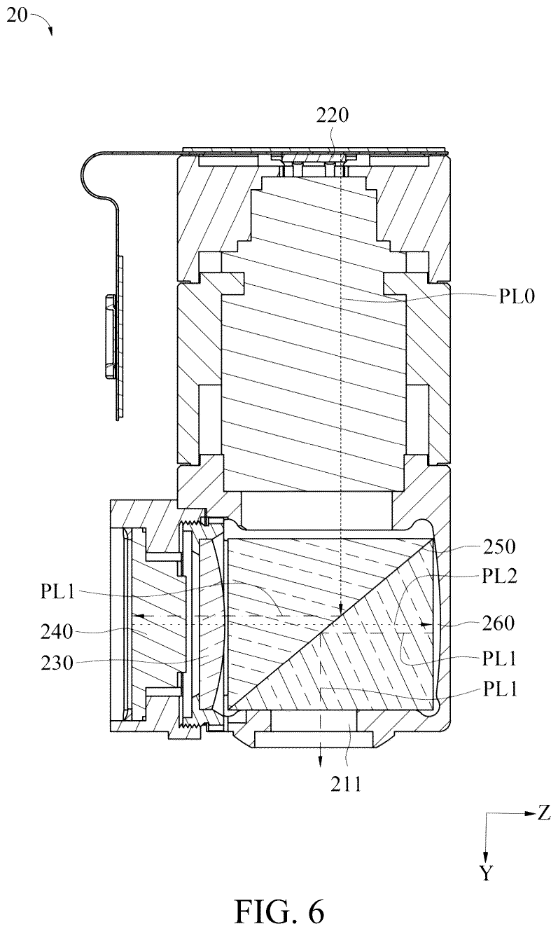

FIG. 6 is a schematic diagram of a traveling route of light in an image module according to an embodiment. In some embodiments, the light source 220 generates the light PL0 traveling in the first direction, and the light PL0 includes first polarized light PL1. The following uses the first polarized light PL1 as S polarized light for description. The polarizing beam splitter 250 has a first side 251 and a second side 253 that face away from each other. A 45-degree angle is defined between a horizontal plane of the first side 251 and the first direction. The first polarized light PL1 in the light can completely pass through the polarizing beam splitter 250, and second polarized light PL2 (namely, P polarized light) whose phase is orthogonal to the phase of the first polarized light PL1 is reflected by the polarizing beam splitter 250.

When reaching the first side 251 of the polarizing beam splitter 250, the first polarized light PL1 in the light source 220 generated by the foregoing light source 220 cannot pass through the polarizing beam splitter 250 and is reflected on the first side 251 of the polarizing beam splitter 250 toward the second direction.

Subsequently, the first polarized light PL1 passes through the lens assembly 230 in the second direction and reaches the modulation assembly 240. The modulator 241 in the modulation assembly 240 changes a phase of the first polarized light PL1 to convert the first polarized light PL1 into the second polarized light PL2 that is orthogonal to the first polarized light PL1 and reflects the second polarized light PL2 in the second direction. The second polarized light PL2 which results from the modulator 241 changing the phase can pass through the polarizing beam splitter 250 without being reflected.

In some embodiments, the exit pupil area 211 of the image module 20 may be disposed in the second direction and located downstream of an optical path of the polarizing beam splitter 250 in the second direction. The second polarized light PL2 reflected by the modulation assembly 240 travels toward the first side 251 of the polarizing beam splitter 250, passes through the polarizing beam splitter 250 and reaches the exit pupil area 211 of the image module 20, and passes through a bracket entrance pupil opening 110 on a bracket 10 from the exit pupil area 211 and reaches an entrance pupil area 510 of a waveguide sheet 50.

In some other embodiments (for example, the embodiment shown in FIG. 6), the exit pupil area 211 of the image module 20 is located in the first direction, and a 45-degree angle is defined between a horizontal plane of the second side 253 and a surface of the exit pupil area 211. In this embodiment, the image module 20 includes a phase delay assembly 260, which is located downstream of an optical path of the modulation assembly 240 in the second direction and is fastened on the housing 210.

The second polarized light PL2 whose phase is changed by the modulator 241 and that is reflected by the modulator 241 passes through the polarizing beam splitter 250 and reaches the phase delay assembly 260. The phase delay assembly 260 may be, but is not limited to, a quarter wave retarder. The phase delay assembly 260 may convert the second polarized light PL2 into the first polarized light PL1 and reflect the first polarized light PL1 to the second side 253 of the polarizing beam splitter 250. As described above, the polarizing beam splitter 250 may allow the second polarized light PL2 to pass through and reflect the first polarized light PL1. When the first polarized light PL1 whose phase is changed by the phase delay assembly 260 and that is reflected by the phase delay assembly 260 reaches the second side 253 of the polarizing beam splitter 250, the first polarized light PL1 is reflected on the second side 253 and reaches the exit pupil area 211.

In some embodiments, a lens group (not shown in the figure) for collimating and shaping light is disposed between the light source 220 and the polarizing beam splitter 250, so that the light before reaching the polarizing beam splitter 250 may be collimated and shaped into uniform light.

In some embodiments, a polarizing element (not shown in the figure) may be disposed between the light source 220 and the polarizing beam splitter 250. The polarizing element polarizes the light PL0 generated by the light source 220 into the first polarized light PL1 before the light PL0 reaches the polarizing beam splitter 250.

In some embodiments, the polarizing beam splitter 250 may be implemented by plating a multilayer film on an inclined surface of a right-angle prism and gluing inclined surfaces of two right-angle prisms together to form a cube structure. The inclined surfaces of the two right-angle prisms are respectively the first side 251 of the polarizing beam splitter 250 and the second side 253 of the polarizing beam splitter 250.

Referring to FIG. 5 again, as described above, the first base body 233 of the lens assembly 230 and the second base body 243 of the modulation assembly 240 respectively include the first thread 235 and the second thread 245, and the second thread 245 and the first thread 235 match each other and can be screwed together, so that the first base body 233 and the second base body 243 partially overlap. In some embodiments, a position of the first base body 233 relative to the second base body 243 can be changed by changing a position at which the first thread 235 is screwed to the second thread 245.

Specifically, when the first base body 233 is rotated, the first thread 235 may be screwed to the second thread 245 by a larger part or a smaller part. When the part by which the first thread 235 is screwed to the second thread 245 increases, an overlapping part between the first base body 233 and the second base body 243 increases, and the first base body 233 and the lens 231 approach toward the modulator 241. Otherwise, the overlapping part between the first base body 233 and the second base body 243 decreases, and the first base body 233 and the lens 231 move away from the modulator 241.

When the first thread 235 is completely screwed to the second thread 245 of the second base body 243, the first base body 233 and the second base body 243 overlap at a position corresponding to the first thread 235 and the second thread 245, and the lens 231 is located at a position closest to the modulator 241. When the part by which the first thread 235 is screwed to the second thread 245 of the second base body 243 decreases, the lens 231 gradually moves away from the modulator 241. When the lens 231 approaches toward or moves away from the modulator 241 with the movement of the first base body 233, an effect of adjusting a focal length of the image module 20 can be achieved.

In some embodiments, a diameter of the lens 231 is greater than a diameter of the modulator 241, so that light entering the modulator 241 or reflected by the modulator 241 is not blocked by the first base body 233.

In some embodiments, the modulator 241 may be implemented by a liquid crystal on silicon (LCOS).

In some embodiments, the second base body 243 is fastened on the housing 210, and a window 215 is provided at a position of the housing 210 that corresponds to the first base body 233 and faces the second thread 245. The user may rotate the first base body 233 by applying pressure to the first base body 233 through the window 215 to adjust a size of the part by which the first thread 235 of the first base body 233 is screwed to the second thread 245 of the second base body 243, thereby adjusting the position of the lens 231 in the second direction of the image module 20.

In some embodiments, the first base body 233 includes a toggling portion 237, and the toggling portion 237 is exposed through the window 215. The user may toggle the toggling portion 237 through the window 215 to enable the first base body 233 to rotate and change the position at which the first thread 235 is screwed to the second thread 245.

In some embodiments, the toggling portion 237 may be in any shape, for example, in a shape of a wave or in a shape of a petal that is convenient for the user to toggle to enable the first base body 233 to rotate.

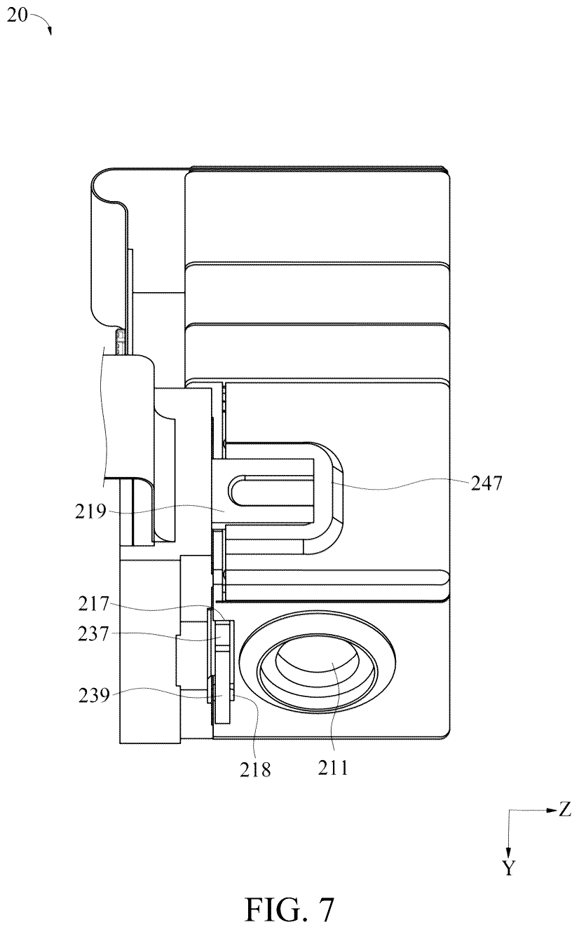

FIG. 7 is a three-dimensional schematic diagram of an image module according to another embodiment. In some embodiments, the toggling portion 237 includes a toggling rod 239, and the toggling rod 239 may protrude beyond the window 215, so that the user can more conveniently toggle the first base body 233 and enable the first base body 233 to rotate. In some embodiments, the window 215 has a first end 217 and a second end 218 that are opposite to each other, and the toggling rod 239 is displaceable between the first end 217 and the second end 218. When the toggling rod 239 is displaced, the toggling rod 239 drives the first base body 233 to rotate to change the position at which the first thread 235 is screwed to the second thread 245.

In some embodiments, when a position of the lens assembly 230 is determined and does not need to be adjusted subsequently, glue may be coated between the first base body 233 and the second base body 243, and the toggling rod 239 may be cut off in a manner such as laser.

Referring to FIG. 5 again, in some embodiments, the toggling portion 237 is located at the window 215, the window 215 has a window height H, and the first thread 235 has a thread length L. The height of the window 215 is greater than the thread length L, so that the first base body 233 has enough space to move in the second direction.

Referring to FIG. 7 again, in some embodiments, the second base body 243 of the modulation assembly 240 includes a buckling member 247, the housing 210 includes a buckling portion 219, and the buckling member 247 may be buckled to the buckling portion 219. A positional relationship between the housing 210 and the second base body 243 may be limited by buckling the buckling member 247 and the buckling portion 219 between the second base body 243 and the housing 210 to ensure that a center of light reflected by the polarizing beam splitter 250 can correspond to a center of the lens 231 and a center of the modulator 241, thereby maintaining a good image effect.

After a position between the lens 231 and the modulator 241 is adjusted, a projection focal length of the image module 20 changes, and clarity of the image projected onto the entrance pupil area 510 of the waveguide sheet 50 varies with the position of the lens 231. In addition, when the clarity of the image is optimal, the position of the lens 231 may be fixed by dispensing glue between the first base body 233 and the second body base body 243.

Referring to FIG. 1 again, in some embodiments, the optical apparatus may include two brackets 10 and two image modules 20 and two adjustment assemblies 30 respectively corresponding to the two brackets 10, and one image module 20 and one adjustment assembly 30 are respectively disposed on two sides of the glass frame body 40. A depth at which the adjustment screw 330 in the adjustment assembly 30 is screwed to the bracket 10 is changed, so that images projected onto the waveguide sheet 50 from the two sides of the glass frame body 40 for the user to view by the eyes can be superimposed, thereby improving bodily sensation and comfort when the optical apparatus is used.

In conclusion, the positional relationship between the image module 20 and the bracket 10 may be adjusted by using the adjustment assembly 30, and the position of the lens 231 in the image module 20 may be adjusted, so that an effect of the image projected by the optical apparatus is increased, and the bodily sensation of the user is improved when the optical apparatus is used.

What is claimed is:

1. An optical apparatus, comprising:
a bracket, comprising a bracket entrance pupil opening and at least one locking hole adjacent to the bracket entrance pupil opening;
an image module, disposed on the bracket, wherein the image module comprises an exit pupil area, and the exit pupil area faces the bracket entrance pupil opening; and
an adjustment assembly, comprising:
an adjustment sheet, fastened on a side of the image module facing the bracket, comprising at least one adjustment hole corresponding to the at least one locking hole;
an elastic member, disposed on the bracket and disposed around the bracket entrance pupil opening; and
at least one adjustment screw, passing through the at least one adjustment hole of the adjustment sheet and being screwed into the at least one locking hole to enable the adjustment sheet to abut against the elastic member.

2. The optical apparatus according to claim 1, wherein the bracket comprises a plurality of locking holes, and the adjustment sheet comprises a plurality of adjustment holes respectively corresponding to the plurality of locking holes, wherein a line connecting centers of at least two locking holes passes through an optical axis of the image module.

3. The optical apparatus according to claim 1, wherein the image module comprises a bearing portion, a groove opening is provided on a side of the bracket facing the image module, and the bearing portion passes through the adjustment sheet and is disposed in the groove opening of the bracket.

4. The optical apparatus according to claim 1, wherein the adjustment sheet further comprises at least one positioning hole, and the bracket further comprises at least one positioning post passing through the at least one positioning hole.

5. The optical apparatus according to claim 1, further comprising:
a glass frame body, wherein the bracket is disposed on the glass frame body; and
a waveguide sheet, disposed between the glass frame body and the bracket, wherein the waveguide sheet comprises an entrance pupil area, and the entrance pupil area corresponds to the bracket entrance pupil opening, wherein a first included angle is defined between a normal of the entrance pupil area and an optical axis of the image module.

6. The optical apparatus according to claim 5, wherein the bracket has an upper surface and a lower surface that are opposite to each other, a second included angle is defined between the upper surface and the lower surface, an angle of the second included angle is the same as an angle of the first included angle, the image module is disposed on the upper surface of the bracket, and the waveguide sheet is parallel to the lower surface of the bracket.

7. An optical apparatus, comprising:
a bracket, comprising a bracket entrance pupil opening and at least one locking hole adjacent to the bracket entrance pupil opening;
an image module, disposed on the bracket, wherein the image module comprises:
a housing, comprising an exit pupil area, wherein the exit pupil area faces the bracket entrance pupil opening;
a light source, disposed in the housing, wherein the light source generates light traveling in a first direction, and the light comprises first polarized light, wherein the exit pupil area is located in the first direction;
a lens assembly, located on an optical path in a second direction that is perpendicular to an optical path in the first direction, comprising a lens and a first base body, wherein the lens is disposed on the first base body, and the first base body comprises a first thread;
a modulation assembly, located downstream of the optical path of the lens assembly in the second direction and fastened on the housing, wherein the modulation assembly comprises a modulator and a second base body, the modulator is fastened on the second base body, the modulator converts the first polarized light into second polarized light that is orthogonal to the first polarized light, the second base body comprises a second thread matching the first thread, and the first base body is screwed to the second thread of the second base body through the first thread; and
a polarizing beam splitter, disposed in the housing, located downstream of an optical path of the light source, and located between the light source, the lens assembly and the exit pupil area, wherein the polarizing beam splitter is capable of reflecting the first polarized light, and the second polarized light is capable of passing through the polarizing beam splitter; and
an adjustment assembly, comprising:
an adjustment sheet, fastened on a side of the image module facing the bracket, comprising at least one adjustment hole corresponding to the at least one locking hole;
an elastic member, disposed on the bracket and disposed around the bracket entrance pupil opening; and
an adjustment screw, passing through the at least one adjustment hole of the adjustment sheet and being screwed into the at least one locking hole to enable the adjustment sheet to abut against the elastic member.

8. The optical apparatus according to claim 7, wherein a window is provided at a position of the housing facing the second thread, the first base body further comprises a toggling portion, the toggling portion is exposed through the window, and the first base body is rotatable in relation to the second base body through toggling of the toggling portion.

9. The optical apparatus according to claim 8, wherein the window has a window height, the first thread has a thread length, and the window height is greater than the thread length.

10. The optical apparatus according to claim 8, wherein the toggling portion comprises a toggling rod, the window comprises a first end and a second end that are opposite to each other, and the toggling rod protrudes beyond the window and is displaceable between the first end and the second end.

11. The optical apparatus according to claim 7, wherein the second base body of the modulation assembly comprises a buckling member, the housing comprises a buckling portion, and the buckling member is buckled to the buckling portion.

12. An image module, comprising:
a light source, configured to generate light traveling in a first direction, wherein the light comprises first polarized light;
a lens assembly, located on an optical path in a second direction that is perpendicular to an optical path in the first direction, comprising a lens and a first base body, wherein the lens is disposed on the first base body, and the first base body comprises a first thread;
a modulation assembly, located downstream of the optical path of the lens assembly in the second direction, wherein the modulation assembly comprises a second base body and a modulator, the modulator is fastened on the second base body, the modulator converts the first polarized light into second polarized light that is orthogonal to the first polarized light, the second base body comprises a second thread matching the first thread, and the first base body is screwed to the second thread of the second base body through the first thread; and
a polarizing beam splitter, located downstream of an optical path of the light source and located between the light source and the lens assembly, wherein the polarizing beam splitter is capable of reflecting the first polarized light, and the second polarized light is capable of passing through the polarizing beam splitter.
